(19) United States
(12) Patent Application Publication
(10) Pub. No.: US 2007/0157994 A1
(43) Pub. Date: Jul. 12, 2007

(54) Methods for making improved strand wood products and products made thereby

(76) Inventors: Christopher Scoville, Carnesville, GA (US); Joel Barker, Townville, SC (US); Feipeng Liu, Statham, GA (US); Jianhua Pu, Bishop, GA (US)

Correspondence Address: William S. Parks, 333 Thornall Street, Edison, NJ, 08837, US

(21) Appl. No.: 11/316,859

(22) Filed: Dec. 23, 2005

(51) Int. Cl. B27L 5/04; B27M 1/00

(52) U.S. Cl. 144/380; 144/363

(57) ABSTRACT

An overall method of making engineered strand wood products in relation to a number of different possible criteria is provided. Such a method may involve any combination of different screening procedures to determine the best wood sources from which individual strands may be prepared. Such screening procedures may include initial determinations of certain physical characteristics of individual logs, further or initial determinations of certain physical characteristics of portions of sawn logs, further or initial determinations of certain physical characteristics of individual strands, and any combinations thereof. Additionally, after the initial physical characteristic sorting is completed, optionally the wood may be cut into uniformly sized and shaped strands for incorporation within a target strand product. Still further, such strands, in substantially uniform size and shape, as well as substantially uniform physical characteristics, may then be incorporated into a target strand product in specific predetermined configurations. Such various possible combinations of screening procedures and/or selective stranding processes results in strand products (boards, lumber, and the like) of improved properties over previously made strand products. Thus, encompassed within this invention are processes involving each of these procedures either individually or in combination with other sequential processes for the production of desired strand products.

### FIELD OF THE INVENTION

This invention relates to an overall method of making strand wood products in relation to a number of different possible criteria. Such a method may involve any combination of different screening procedures to determine the best wood sources from which individual strands may be prepared. Such screening procedures may include initial determinations of certain physical and mechanical characteristics of individual logs, further or initial determinations of certain physical characteristics of portions of sawn logs, further or initial determinations of certain physical characteristics of individual strands, and any combinations thereof. Additionally, after the initial physical characteristic sorting is completed, optionally the wood may be cut into uniformly sized and shaped strands for incorporation within a target strand wood product. Still further, such strands, in substantially uniform size and shape, as well as substantially uniform physical characteristics, may then be incorporated into a target strand product in specific predetermined recipes and configurations. Such various possible combinations of screening procedures and/or selective stranding processes results in strand products (boards, lumber, and the like) exhibiting customized properties. Thus, encompassed within this invention are processes involving each of these procedures either individually or in combination with other sequential processes for the production of desired strand products.

### BACKGROUND OF THE INVENTION

Laminated strand lumber (LSL), oriented strand boards (OSB), and oriented strand lumber (OSL) have been widely used as structural components for roof, wall, I-joist, sub-flooring, and other structural members and assemblies in residential and commercial construction applications. Such products have generally been made from sources such as Douglas Fir, Southern Yellow Pine, Aspen, Yellow Poplar and other species of trees, and particularly, in terms of efficiency, have been produced through the utilization of complete logs. For these strand wood products, the general method entails the utilization of cut logs that are introduced within a conveyor system at the end of which is an apparatus to implement the generation of the needed wood strands for further board and lumber production (such as a strander, flaker, waferizer, or saw, as examples). The strands are then dried and configured in a layered manner with resin incorporated therewith. The layered strands are then pressed together to form the desired strand product. As such, the general method of strand product manufacture utilizes entire logs for such a purpose (some detection is utilized solely to determine if nails or other potentially dangerous items are present within such logs during the stranding procedure).

More particularly, state of the art OSB manufacturing processes typically involve initial conditioning of logs (of various species) in a water vat. These logs then pass through metal detectors to remove metal contaminants, debarked, and stranded into defined strand sizes. The strands are then transported into either tri-pass or single pass dryers or drying tunnels to reach targeted moisture content. Furnishes are screened into different components and added into separated storage bins as face or core layer materials. Strands that are screened out below certain mesh sizes, normally less than ⅛″ meshes, are discarded and used as fuel to generate the heat energy necessary for the plant operation. In general, 95-98% of the overall wood resource can be utilized for making oriented strand boards. Polymeric resin materials are pre-blended with both face and core materials with a preferred resin loading level. Orienting and forming equipment align the resin-coated face and core furnishes into loosely packed mats or sheets before compressing under sufficient heat and pressure into composites with desirable performance [i.e., a modulus of elasticity (MOE) at about 1.0 (mmpsi)].

Similar to the above-described OSB manufacturing process, the typical state of the art LSL/OSL manufacturing process involves the initial conditioning of aspen and/or yellow poplar and/or other special hardwood species in a water vat to soften the logs before further processing. After the usual steps of removing metal contaminants and debarking, the logs are cut into strands with a target length of 12 inches. A disk screening step removes the shorter strands. The strands are then dried to their target moisture contents with single-pass rotary dryers. After drying the strands are re-screened with a disk-screening device to eliminate the broken smaller strands. The dried and screened long strands are then stored in temporary storage bins or buffer areas before being blended with polymeric resin and other additives. Short strands are generally discarded (both wet and dry short strands) in the typical LSL manufacturing process. Loss from the discarded strands can account for as much as 20% of the raw log materials, thus making this typical process inefficient from a total use of wood resource perspective. Polymeric resin such as diphenylmethane diisocyanate (MDI), melamine urea formaldehyde (MUF), and the like, are then applied onto the remaining longer strands in a rotating drum blender. These strands are laid into a unidirectional mat with the aid of common orienting means, such as orientating disks. This loose mat is then hot pressed, typically with a steam-injection press, to create a billet with a uniform and flat vertical density profile across the thickness of the product. The target product produced in this process usually has a MOE value of 1.3 mmpsi or higher. Various engineered wood products are highly desirable for different applications in residential markets. Of particular importance, it is well known that the modulus of elasticity of an engineered wood product (EWP) from 0.8 to 2.5 mmpsi is a key index for determining the accepted performance levels of such products for different applications. More specifically, it has now been determined that the greater the consistency in MOE characteristics for certain end-use products helps to provide greater flexibility for builders in providing better wood constructions for special applications. A method of producing products with such targeted MOE values has, unfortunately, not been available to the industry to date.

There are various factors affecting the properties of those engineered wood composites as mentioned above. The major controlling factors include raw material selection and manufacturing processes. The current production method (for any of OSB, OSL, and/or LSL materials) simply processes tree logs in whole to produce the end product with relatively little control over the natural variability inherent to tree logs. Thus it would be desirable to improve such a process with additional controls to minimize the variations in the quality of the feedstock. It is well known that wood is a natural material with inherent variability. Juvenile wood has less mechanical strength than mature wood. Even within the same log, the outer portion of the log may possess more mature wood than that in the inner core. This is also true length-wise where the bottom part of the log has more growing years than the top part. The associated physical and mechanical properties can have coefficients of variation of 20 to 34% (Green, et al. Engineered Handbook, Mechanical Properties of Wood, Chapter 4). The natural variability in logs leads to significant variations in the properties of the final products even for logs of similar size and density. Again, to date, these two aims have not been met.

Furthermore, as naturally grown logs with larger diameter become less available and more expensive, strong market demands for higher quality structural building material have been met through advancing the raw material manufacturing technology and developing innovative new types of structural reconstituted wood-based composites. For example, high speed sawing and computer controlled laser cutting technology have been widely used for optimizing the log recovery in lumber industry by reducing the edgings, trimmings, sawdust and shavings.

The main drawback of the currently available wood technologies is that no matter how good the process design is, the natural defects and variations of wood, particularly with small diameter logs from younger tree plantations, i.e., juvenile wood remains unchanged. The mechanical strength and stiffness of juvenile wood are much less than those of matured wood. In order to maximize raw material supply, the juvenile wood logs are often mixed with other mature logs, and are processed together to form engineered wood composites. Unfortunately, the mixing of different age logs adds additional variability to the final product.

In response to the diminishing availability of larger diameter sawn logs and increasing supply of smaller diameter logs with a higher percentage of juvenile wood, many manufacturing processes have been developed in the past 20 to 30 years or so to overcome the problems associated with this natural variation. Typical approaches include screening and controlling the strand orientation by using longer and larger strands (U.S. Pat. Nos. 4,061,819, 4,610,913, 4,751,131, and 5,096,765), cutting the strands into uniform width for better alignment (U.S. Pat. No. 6,039,910), and thinner strands with a target thickness of 0.030 to manufacture high-performance oriented strand composites (Zhang, et al. J. Wood Sci. 1998, 44:191-197). As it concerns longer and larger strands, it was the accepted belief in the past that strands of 8″ inches or longer (in particular, 12-inch lengths have been used most widely) would be particularly necessary to impart the desired strength levels due to the uniformity of such long, and apparently strong strands. This has not proven to be true, however, in particular the difficulty in producing such long strands without excessive breakage and thus significant amounts of waste resulting thereof.

This limitation is most notably due to differentiation of the individual wood portions present therein. It has been determined that 12-inch long strands present great difficulties in strand product manufacturing with regular oriented strand manufacturing facilities, particularly from an efficiency standpoint. As noted above, the longer the strand, the more susceptible the strand is to breakage during any of the process steps for strand production, drying, resin incorporation, layering, etc., such that as much as 20% of the total strands may actually be rendered ineffective and thus waste during the overall production process. Furthermore, even if the utilization of varied length and widths of strands is followed (as is typical of the vast majority of strand product manufacturing schemes), the quality of the individual strands themselves, if not the overall quality of the source wood utilized therein, has proven to result in less than stellar performance of the target strand product. The ability to utilize shorter strands, or the ability to reduce waste strands while retaining and/or providing a board with the same strength characteristics thereof, is thus a highly desirable aim of the industry in terms of resource utilization. To date, no such improvement has been provided, however.

As such, it has now been determined that a number of different possible processes, individually, or (potentially preferably) in combination with any number of others, provide bases for tailored manufacturing wood oriented strand products, either in terms of product performance or wood resource utilization efficiency, or both. As noted above, no other method or methods has permitted such improvements on the oriented strand products to date.

### SUMMARY OF THE INVENTION

It has thus been realized that significant advantages for the production of engineered wood strand products including, but not limited to, laminated strand lumber (LSL), oriented strand lumber, and oriented strand board, have been accorded the industry in terms of the ability to selectively produce products with desired physical properties with reduced variability in the finished product.

Accordingly, this invention encompasses a method of producing an engineered wood product, the method comprising initially sorting logs by any of the following raw material characteristics: a) modulus of elasticity; b) density (or specific gravity); c) size and shape; and any combinations of the above thereof; stranding only those logs that exhibit similar raw material characteristics per predetermined sorting criteria; and incorporating the strands made therefrom within said engineered wood product. The invention also encompasses a method as above, but, prior to stranding, the logs selected in accordance with the criteria are cut into lumber pieces which are then subsequently sorted for the same raw material characteristics as mentioned above; and then if the individual lumber pieces meets the criteria (MOE and size requirements), such lumber pieces are then stranded for further processing into the desired engineered wood product. In essence, such log and/or lumber is sorted into varying grades and utilized to produce different grades of engineered wood products depending upon the raw material characteristics of the original source material. This method thus, as alluded to above, permits more efficient utilization of wood resources in order to ultimately provide a method to tailor end product formation and performance dependent upon desired physical and/or mechanical properties of the target engineered wood product itself for different applications. The overall method thus permits sequestration of different portions of logs and/or lumber for the production of engineered wood products having different properties by utilizing different categories of strand components provided subsequent to such a sorting procedure. Thus, less waste of wood resource is followed while specific engineered wood products tailored for certain physical and/or mechanical properties are provided simultaneously. Also encompassed within this invention is a method of initially cutting logs into individual lumber pieces as above and then following the same sorting process (but without first sorting the logs themselves). Also encompassed within this invention is a method of producing such an engineered wood product as above, except that after either the log sorting procedure, or the lumber sorting process, or both, if both procedures are followed, the individual strands produced therefrom are cut into substantially uniform length and width and are then utilized to produce an oriented strand wood product therefrom. Optionally, within any of the processes noted above, the logs or lumber are initially conditioned in water baths prior to stranding. Although optional within the inventive method, it has been found that lumber or board pre-treatments are highly desirable in order to have supply high quality wood strand elements within such strand product manufacturing processes. Further encompassed within this invention are the oriented strand wood products produced by such methods as well as the oriented strand wood products produced from the strands that do not meet the criteria stated above.

### DETAILED DESCRIPTION OF THE INVENTION

The term “engineered wood product” is intended to encompass oriented strand boards, oriented strand lumber, and laminated strand lumbers.

At its most basic, the overall invention may thus be considered as follows: a manufacturing process includes the steps of (1) sorting individual logs into groups categorized by at least one measurement selected from the group consisting of a) modulus of elasticity (MOE), b) log specific gravity, c) log diameter, d) log length, e) log shape (curvature, ovality, etc.), and f) volume, and (2) subjecting selected logs in such categories to stranding and subsequent board or lumber production. Optionally, after step (1), another sorting process for any of the measurements noted above may be followed after selected logs are first sawn into lumber portions and then stranding is undertaken. In such a manner, a log or lumber section may be categorized in terms of such different mechanical properties permits the utilization of the proposed lumber sections for the production of strand wood products requiring a range of stiffness and strength properties through the ability to categorize tree and tree sections as mature, juvenile and compression wood.

More specifically, then, one aspect of this invention is a method of sorting logs into two or more categories based on a number of possible pre-determined criteria of material properties through a variety of monitoring technologies, but most particularly, the MOE of the log and then utilizing the strands produced from each separate category for specific types of end-use strand wood product applications. The highest MOE logs can be then sent to a conveyor line to be used in high MOE OSL or superior OSB products. The lower MOE logs will be sent only to the low-MOE product lines, such as commodity OSB. Strands from the low quality logs could be placed in the core or intermediate layers of a 3-layer product; or the low quality materials could be used in the intermediate layers in a six-layer product. This classification allows mills to manufacture an engineered wood product of high performance due to the less variation of raw log material properties.

The basic idea for determining the logs or lumber MOE includes that logs will be scanned with laser scanners to accurately and quickly compute the volume of the log, with the weight of the log then measured by load cells. These parameters are automatically entered into a computer and the MOE of the log is determined by one or more of three basic methods: Static Bending, similar to MSR rating (via a load-deflection method); stress-wave timing; and dynamic vibration analysis (acoustic measurements such as that of low frequency ultrasonic transmission times throughout a subject log or lumber piece). The log (or lumber piece) will then be assigned a stiffness parameter associated with the calculated results of all these tests, taking into account the volume, diameter, MOE, density, etc. Log conveyors and sorting mechanisms will then move the log to one of two or more conveyor systems, according to the determination of the final products assigned to the log.

Furthermore, wood and wood-based composite materials do not have uniform strength and stiffness properties from specimen to specimen, or even within the same specimen. Since wood materials are grown in a natural environment, the material contains such deviations in uniformity as knots, grain deviations, high- and low-density locations, and different amounts of growth rates and juvenile wood due to the variability in growth conditions, available nutrients, sunlight, climatic factors, etc. In order to improve the yield and tailor the specific attributes of structural lumber, an accurate in-line measuring method of quickly determining the stiffness of the lumber has been in use for many years. One example of the equipment for MSR rating of lumber is the CLT from Metriguard, Inc. (U.S. Pat. Nos. 5,503,024 and 4,991,446).

The machine stress rating of lumber has been in use for many years in lumber production plants, replacing the visual grading of lumber. MSR rating allows a decrease in the uncertainty of the actual strength and stiffness of the lumber. Prior to the development of MSR, only visually-detected characteristics such as grain orientation and density, weight, location and size of knots and other natural and process defects, etc., were used to determine the approximate stiffness and strength characteristics of a piece of lumber and these characteristics were compared to a large-scale laboratory testing procedure that actually breaks many pieces of similar lumber to get an idea of the bending strength and stiffness.

In a structural composite lumber or structural wood composite panel production process, logs are normally fed into the system without too much regard to the strength and stiffness of individual logs, mainly basing the logs sorting on species or log diameter only (see attached example of current OSB process).

MSR lumber graders use a known displacement and a load cell to measure the load use a correlation equation to get the basic bending modulus of the specimen. The advantage is that the rollers allow for a high volume of lumber to be passed through the tester in a short time period, matching the very fast line speeds in a lumber production mill. For logs, a similar theory would be applied, using an equation to represent the bending stiffness of a round cross section instead of square.

Static bending analysis is followed through the alignment of logs in a test frame machine as part of the automatic process of the log line on the in-feed side of an engineered wood products manufacturing plant. The logs are singulated and passed through an inline laser gauge or other dimensional measurement device to allow an approximation of the log diameter along the length of the log. These dimensions are necessary for the calculation of the bending stiffness. The log is then passed through an inline test frame that subjects the log to a simple support bending configuration. The two support members and loading head will be made of a shape that allows different diameter logs to be supported and loaded without negatively affecting the accuracy of the load measurement. The load will be measured by one or more load cells in the base of the loading head. The load, length, and dimensions of the logs will be recorded automatically using a data acquisition system and the MOE of the logs will be calculated with those parameters and a calibration curve.

After the stiffness of the logs are determined, the log will be moved out of the bending fixture and sent into a series of log sorting devices. The log sorting devices will track the location of the log and send it to a predetermined log stacking location, based on the stiffness, size, and other characteristics which control the usefulness of the log in the production of different structural wood composite products. For example, logs with a higher average stiffness will produce lumber and indeed flakes of a higher average stiffness with desirable properties for high-strength and stiffness wood products such as Oriented Strand Lumber or Laminated Strand Lumber. Logs with lower properties will be more suitable for processes such as Oriented Strand Board, Particleboard, or low-property OSL or LSL.

Another MOE measurement possibility for logs (or lumbers) involves subjecting such specimens, while being picked up by the ends, to a timed repeatable impact vibration from one log end to the other. This procedure allows a stress wave speed calculation to be performed and subsequently correlated to the log (or lumber) MOE in relation to the subject's density and diameter (as noted below within Equation 1).

Longitudinal stress-wave nondestructive testing techniques have been used frequently with a high degree of success in the forest products industry and other industries, namely structural steel manufacturing, fiber-reinforced polymers, reinforced concrete and others. The technique is used to evaluate various wood and wood-based products. Stress-wave timing includes grading of veneer for laminated veneer lumber products, in-place assessment of timbers in structures, and decay detection in trees. Other studies have shown that stress-wave methods have been used to predict the MOE of logs in a nondestructive manner. A strong relationship was established between stress-wave determined dynamic MOE and static bending MOE of logs, as well as for cants and lumber sawed from the same logs. The utilization of such a technique in correlation to strand selection and production has not been practiced, however.

Generally, the MOE of a log via longitudinal stress-wave testing is determined by the equation: MOE_{d}=C²ρ [Equation 1], where MOE_{d}=apparent modulus of elasticity, measured dynamically, C=wave speed, and ρ=gross density. Diameter has been shown to have an effect on the stress wave speed (Wang et al 2002). Although moisture content, temperature, and grain angle, and knots also have an effect, very good correlations exist (R²=0.73 to 0.92) with the use of only log density, diameter, and stress wave speed, and a slightly modified variation of the Equation 1. The equation that related MOE to density, stress wave speed and diameter is as follows: MOE_{d}=a(C²ρ)^{b}D^{c} [Equation 2]. The equipment needed for stress wave timing includes accelerometers, a computer data acquisition system, and a hammer or other repeatable vibration inducing system. One commercial system is the Metriguard Model 239A Stress Wave Timer (Metriguard, Pullman, Wash.). One example of a commercial impact hammer is made by IML GmbH, Wiesloch, Germany.

A variation of the stress wave timing is also described as an ultrasonic approach to measuring the modulus of materials. The equation is the same, but the type of vibration that is induced and then measured at the other end of the log changes from an impact type of vibration to a frequency transducer in the range of close to 22 kHz. The principle is similar as well as the effects of MC, density, log shape, etc. One commercially available system is the James “V” Meter from James Instruments, Chicago Ill. Another system that is well known in the research is the SylvaMatic or SylvaTest Duo, from Sandes SA, in Granges, Switzerland.

In terms of log and/or lumber sorting, then, such measurements for MOE and the like are possible. Once the logs are sorted in accordance with average overall measurements, the different groups can then be utilized for the production of different types of strands in accordance with the physical characteristics of the sorted logs and/or lumber. One is that each separate group can then be utilized to produce strands of different types (in terms of MOE, for instance). The strands from each different group can then be utilized either to produce different degrees of strand wood products in terms of overall strengths, or such as in layered oriented strand board or lumber products, higher MOE strands may be incorporated within outer layers thereof while the lower MOE strands may be introduced within and inner layer or layer. Or, the sorted logs may then be sawn into lumber pieces for further analysis of the different regions of the already-sorted logs. In the same manner, then, the lumber pieces may be subjected to the same tests as noted above to determine the specific regions of the lumber that includes the higher MOE and lower MOE (as one possible example of measurements to be taken) and such regions may then be separated and grouped together to, as noted above, provide more uniform strands ultimately in terms of such physical properties.

Other parameters may also be utilized as selection criteria of sorting of logs and/or lumbers in addition to those discussed above. For instance, it is well known to the wood and wood-based composite industry that both log species and log moisture content are critical in the manufacturing processes, and an effective log sorting procedure would benefit the consistency of the process and the quality of the products. However, current log sorting practice does not address these two additional parameters simultaneously, and particularly not at the pace of the production. Thus, it has now been determined that adding one or more additional sorting criteria, such as (1) log moisture content, (2) log specific gravity (3) log diameters, (4) log lengths, (5) log shapes (curvature, ovality, etc.) and volume, to the existing sorting process improves the quality and yield of the products being manufactured and reduces cost. Such a system can also be retrofitted to sort dimension lumber and timber products, Glulam, LVL, PSL, LSL, OSL, and OSB products. For log sorting, it can be integrated into the log yard operations in a saw mill, a plywood/LVL plant, a PSL plant, an LSL plant, an OSL plant, an OSB plant, and a pulp and paper mill. With the added sorting capabilities in log moisture and specific gravity, incoming logs can be sorted by log moisture, by species, by the content of juvenile wood, etc., in addition to by log dimensions (diameter, length, and volume) and shapes traditionally used in the saw mill operations.

One drawback to the previously discussed prior improvements for strand wood products is that the increase in lengths of strands tends to create its own disadvantages for the producer, primarily in terms of strand handling. In practice, the approach of using longer strands for the manufacturing of laminated strand lumber or oriented strand board is difficult to be fully realized. Strands made on the available industrial slicing machines are often broken into random widths along the wood grain. Crooked logs with twisted grain will either cause breakage of the longer strands or the strands do not separate completely and interlock with each other during processing. Interlocked or bundled strands prevent smooth passage through the dryer and the blending system and prevent good orientation of the strands. The removal of the dried, shortened, broken strands creates waste and increases cost. Furthermore, the strands with irregular widths will twist and split during the drying process so that the strand orientation will be negatively affected in the forming step, resulting in high resin consumption and lower quality lumber products. It is thus one possible embodiment to provide not just rough uniformity in strand MOE (or the like properties), but also length and width.

Additionally, it is well known that furnish qualities have significant impact on strand alignment and final product quality. In the alignment process, furnish strand dimensions greatly affect the ability of the mechanical equipment to align the strands. When producing LSL and OSL type products the strands are aligned all parallel to the machine direction. Variability in strand dimensions greatly affects a machine's ability to maintain a consistent angle of orientation. It is known that strand quality and alignment within a board or compressed lumber product are related. In fact, it is widely understood that the alignment angle of such long strands must be maintained within ±10 degrees to the direction of intended orientation. Variations from this angle will reduce MOE of the ultimate wood product considerably thus yielding products that will not meet mechanical property specifications. As such, it was found that the utilization of varied length and width strands, even of lengths greater than 12 inches on average, will greatly affect the ability of the mechanical orienter to achieve the ±10-degree alignment during the mat formation process. Thus, the determination was made that the uniformity in the length and width of the high MOE strands permits production of strand products of optimal strength and low-warpage.

In preparation of raw wood furnish materials for making engineered wood structural lumber products, high quality wood strand elements are desirable for making products such as laminated strand lumber (LSL) and oriented strand lumber (OSL), or oriented strand board (OSB) products. The preferred wood strands have uniform dimension in length from 4″ to 12′, width from 0.20 to 3″, and thickness from 0.010″ to 0.050″.

The ability to align strands is highly correlated to the strand dimension and uniformity. A 3-D stranding process as described in U.S. Pat. No. 6,035,910 to Schaefer, a veneer strip manufacturing process with uniform size and length and thickness. This process defines the use of lumber to manufacturer strands of exact length, width and thickness with reduced variability as compared to existing 2-D stranding processes that are typically used in the manufacturer of OSB products.

Such stranding makes it easier to obtain the desired degree of uniformity in all three dimensional measures noted above. Since MOE uniformity is of great concern, it was determined that certain levels of such a property were of great benefit to the selected end-use applications. For example, in the case of regular OSB products, the MOE value is around 0.47 to 1.14 E (mmpsi) along the major panel axis and 0.08 to 0.36 E (mmpsi) across the major panel axis, respectively. For premium OSB products, the MOE ranges are 0.75 to 1.15 E and 0.25 to 0.5 E, respectively. For I-joist components, the minimally required MOE is about 1.50 E (mmpsi). For short span header and beam applications, a minimally required MOE value is about 1.30 E (mmpsi). For railroad ties, the required MOE value is equal to or above 1.80 (mmpsi). For specialty structural beam products the MOE required by the customer may be as high as 2.1 (mmpsi).

Also, the wood strands are manufactured by a two-step stranding process plus an extensive screen-out operation or an addition of lumber cutting step to the two-step stranding processes plus less screening out operation.

In addition, the product manufacturing processes are similar to that of oriented strand board (OSB), in which the strand elements are dried, screened, pre-coated with polymeric resin, oriented primarily along the strand length direction into thicker mats, and consolidated into flatten composite billets by either steam injected press or pre-heated Conti-Roll™ hot press machine.

The size of the LSL/OSL products will be:
Thickness: 1″ or above
Width: 4 feet or above (similar to typical sawn lumber/timber with flexible cut width)
Length: similar to typical sawn lumbers with flexible cut length
Density: 35 to 50 (Ib/ft³)

The resultant strand wood product is used as a substitute of sawn lumbers, LSL, LVL, and regular OSL for residential and industrial markets. Such a product exhibits attributes that have heretofore been unavailable within the strand wood product industries, including strands having a maximum strength/stiffness along the strand length direction, behaving equivalently in bending MOE across the strand length direction, a single product for multiple utilization including as I-joist flange, beam headers, railroad tiers, and the like, and a product manufactured effectively with less or no downtime (no need to switch between types of products).

Such OSL/LSL composites can be distilled to the following guidelines in terms of production schemes. The wood species may be softwood such as Southern Yellow Pine or hardwood such as Aspen and/or Yellow Poplar. The other raw materials used in production include polymeric resins or/and binders (such as MDI resin, melamine formaldehyde resin, phenol formaldehyde resin, resole formaldehyde resin, urea formaldehyde resin, and blends or copolymers thereof), water repellents, emulsion wax/slack wax, and other special chemical additives, like fire retardant chemicals and chemical preservatives. Isocyanates are the preferred binders, and more preferably those selected from diphenylmethane-p,p′-diisocyanate group of polymers which have NCO— functional groups that can react with other organic groups (such as polyols, for instance) to form polymers with monomers of urea and urethane. Most preferred is 4,4-diphenyl-methane diisocyanate. A suitable commercial MDI product is Rubinate 1840 pMDI available from Huntsman Corporation. Suitable commercial MUF binders are the LS 2358 and LS 2250 products from the Dynea Corporation.

The binder loading level is preferably in the range of about 1.5 to about 20%, of the total oven-dry weight of furnishes, more preferably about 3 to about 10%. A wax additive is commonly employed to enhance the resistance of the OSB panels to moisture penetration. Preferred waxes are slack wax or an emulsion wax. The wax loading level is preferably in the range of about 0.5 to about 2.5%.

After the strands are cut they are dried in an oven to a moisture content of about 2 to 5% and then coated with one or more polymeric thermosetting binder resins, waxes and other additives. The binder resin and the other various additives that are applied to the wood materials are referred to herein as a coating, even though the binder and additives may be in the form of small particles, such as atomized particles or solid particles, which do not form a continuous coating upon the wood material. Conventionally, the binder, wax and any other additives are applied to the wood materials by one or more spraying, blending or mixing techniques, a preferred technique is to spray the wax, resin and other additives upon the wood strands as the strands are tumbled in a drum blender.

After being coated and treated with the desired coating and treatment chemicals, these coated strands are used to form a multi-layered mat. In a conventional process for forming a multi-layered mat, the coated wood materials are spread on a conveyor belt in a series of two or more, preferably three layers. The strands are positioned on the conveyor belt as alternating layers where the “strands” in adjacent layers are oriented generally perpendicular to each other.

After the multi-layered mats are formed according to the process discussed above, they are compressed under a hot press machine that fuses and binds together the wood materials to form consolidated OSB panels of various thickness and sizes. Preferably, the panels of the invention are pressed for 1-10 minutes at a temperature of about 175° C. to about 240° C. The resulting composite panels will have a density in the range of about 35 to about 50 pcf (as measured by ASTM standard D2395) and a thickness of about 0.6 cm (about ¼″) to about 6.35 cm (about 2½″).

Additionally, conditioning logs or sawn lumber/boards is believed to improve the uniformity of wood strand elements greatly and much fewer fines will be generated in the manufacturing processes as a result. In addition, the electric power consumed in stranding the conditioned logs or board/lumber materials will be much less than stranding logs or boards without conditioning. The surface quality of strands from logs or boards conditioned with water or steam will also be improved greatly thus better bonding between adjacent wood strand elements can be achieved.

However, the current methods for producing high quality strand elements have the following drawbacks. Conditioning logs requires a long retention time for the core of the logs to reach preferred temperature and moisture content to yield good quality strands. Proper conditioning of logs would require a very large processing space and have a high cost to process different sizes of logs. It has been observed that the processes currently used generate high levels of fines and low quality strands for the production of OSB, and make the production of OSL cost prohibitive. Likewise, the 3-D stranding process only addresses the problem of creating strands with uniform width, and does not address any of the problems associated with stranding frozen or dried board/lumbers. In fact, stranding frozen lumber can produce more strands than stranding frozen logs.

Now, it has been determined that incorporating water conditioning of logs and/or sawn lumbers in the disclosed manufacturing processes (i.e., in water ponds, vats, and/or via water spraying, and/or hot water/steam injection online processes to raise the temperatures at the center of the subject log and/or sawn board/lumbers to a minimum of melting temperature) will significantly shorten the time needed for de-icing and softening the logs/sawn boards to the desirable moisture content and temperature before stranding. As a result, more uniform and higher quality wood strand elements can be manufactured for making high performance oriented strand lumber (OSL), laminated strand lumber (LSL), or high performance OSB products by incorporating such conditioning steps.

The overall method can thus be listed generally as follows: Optionally, pre-sort logs by species and diameters with sorting means,
1. Logs are then cut into lumber or boards
2. The lumber/boards are graded by MOE by an analyzer via load deflection, stress-wave, and/or dynamic vibration tests to provide a MSR (Machine Stress Rating) and stored by grade for the production of specified products.
3. The lumber/boards can be stored in a warehouse or bin, by MSR ratings for strength, or preferably the lumber/boards are conditioned by steam, hot water, or similar before being conveyed to the strander (this includes a heat treatment selected from the group consisting of steam treatment, and/or hot water immersion with minimum water temperature of 1° C. or above, and, more specifically within a vat exhibit a water temperature of from around 20 C to 70° C.; alternatively, hot steam can be either directly used for pre-treating the logs and/or lumber, and/or a combination of the above two methods thereof). Ring or disk type stranders may be used.
4. The lumber/boards are then fed for a specific product to a stranding device to strand to specific size and shape.
5. The strands are then fed into a dryer to be dried to specific moisture content and then blended with the appropriate glues or resins.
6. The strands are then formed and oriented into a loose mat and then pressed at temperatures of 380-440° F. and pressed at pressures of from 200 to 1000 psi specific matt pressure.

The advantages of such a process include (without limitation): (a) sawing or cutting boards/lumber from a given tree and then storing the lumber/boards by strength as measured by MSR (Machine Stress Rating); (b) conditioning lumber/boards for better strand quality, fewer fines generation, less power consumption, and longer knife life; (c) production of OSL products that are stronger than products produced in today's market; (d) a more efficient process that reduces waste and reduces operating cost; (e) reduced variability; and (f) improving dimensional stability (swell, warp, linear expansion, etc.) by categorizing the lumber/board segments that have adverse performance attributes. This allows for a more efficient use of the tree components within a varying array of commercially produced lumber products.

As noted above, uniformity in wood strand dimensions aids in improving structural wood composite performance in addition to sorting procedures. Such creation of uniform wood strands can be carried out with three alternative methods. (1) A two-dimensional process where regular logs are first stranded based on length and thickness with scoring knives and projected knives while counter knives controlling the width of the strands. The resulting strands have randomly distributed width. Extensive screening operations are currently applied to obtain desirable and preferred strand sizes for the making of laminated strand lumber. The preferred strand sizes include: length>=8″, width: >=0.25″ and thickness <=0.05″ preferred 0.03″. This is the traditional process that is limited to individual tree selection. (2) A three-dimensional stranding process, as described in U.S. Pat. No. 6,035,910 to Schaefer, a veneer strip manufacturing process with uniform size in length, width, and thickness. This is obtained by (a) cutting the wood logs into boards with a uniform thickness corresponding to the predetermined width of the strands, the predetermined width being transverse to the fiber of the veneer strips to be produced, (b) clamping the boards together, and (c) machining the clamped boards to form the veneer strips. (3) A veneer peeling procedure wherein such components may be peeled from selected trees and clipped into strands for later forming and orienting.

The proposed invention is an improvement to the Schaefer concept by adding MSR log an/or lumber measurement equipment that will allow logs and/or lumber to be sorted by strength and then strand for use in designated product strength categories. More specifically, pre-conditioning of lumbers or boards are favorable in order to obtain high quality wood strands with exceptional qualities. This process allows for maximum utilization of strands and allows for the production of much stronger products by capitalizing on using the strongest portions of the tree.

### BRIEF DESCRIPTION OF THE DRAWINGS

FIG. 1 is a diagrammatical representation of the overall process of sorting sawn lumbers to produce a wood strand product.

FIG. 2 is a diagrammatical representation of the overall process of sorting logs to produce a wood strand product.

### DETAILED DESCRIPTION OF THE DRAWINGS

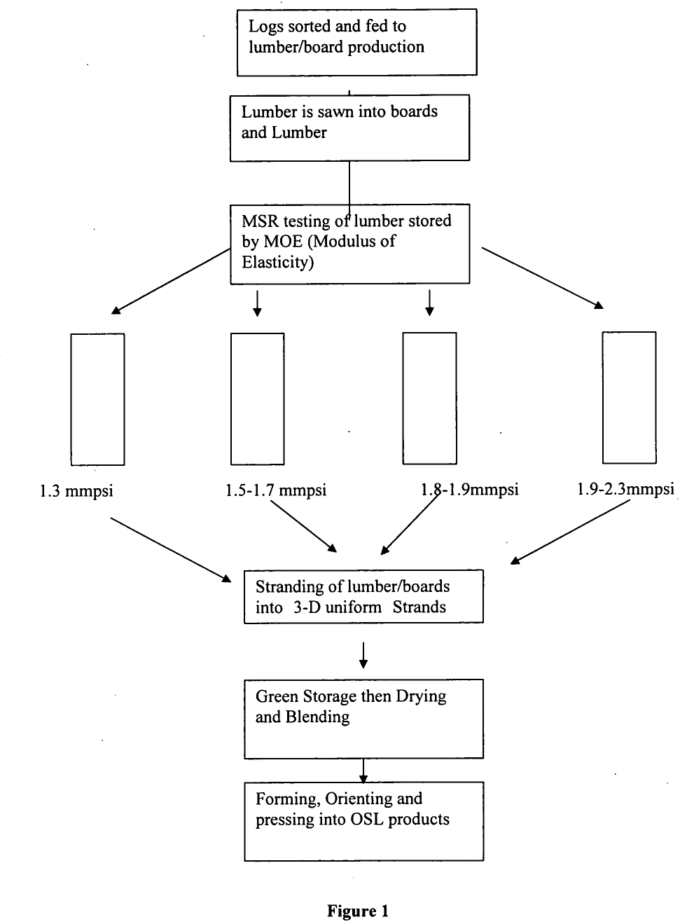

The representation provided within FIG. 1 basically follows this general inventive scheme:
(1). Optionally, logs may presorted based on their diameters, species and density and stored in log yards into separate stacks.
(2). Logs are then cut into lumber/boards.
(3). The lumber is then stored by MOE for later feed to the strander or immediately fed to the strander for production of strands. Optionally the lumber/boards may be conditioned using either steam or hot water or alike before the stranding process.
(4). The bundles of lumber/boards are then fed into the stranders for strand production
(5). The strands are then stored in green bins and then fed to single pass, multi-pass or conveyor dryers to be dried to the specified moistures.
(6). Strands are conveyed to the blenders where they are mixed with the appropriate resins, waxes, etc.
(7). The strands are then aligned into mats with usual orientating means such as an orientating disk.
(8). The loosely packed mats are then heat pressed to desirable thickness with appropriate compaction ratio.
(9). The resulting product can then go through the usual finishing steps, i.e., trimming, cutting, stamping, sanding, edge treating, packaging, etc.

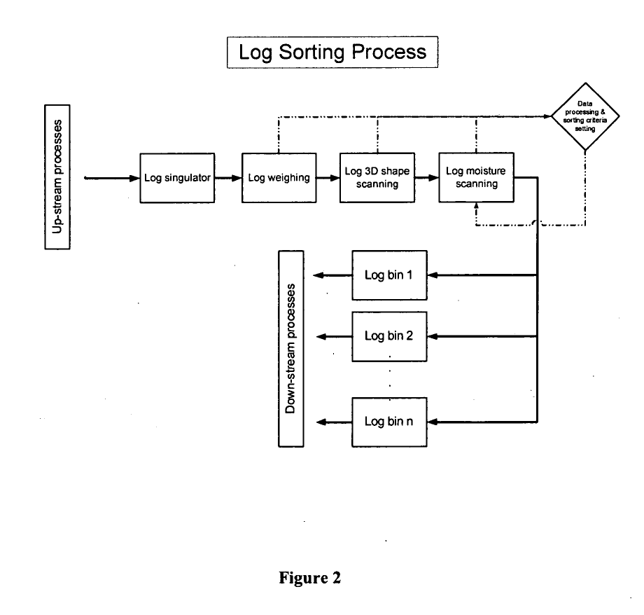

As shown in FIG. 2, the incoming logs from the log yard or other similar up-stream process are first singulated. A single log then travels on to a weighing conveyor where its weight is measured while traveling in the process line speed. The 3D true shape of the log, the actual log length and diameters are obtained from the 3D scanner after the weighing conveyor. The log moisture scanner detects log moisture and moisture distribution along the entire volume. At this point, all the parameters collected are stored in the computer and log specific gravity is calculated with moisture corrections. Depending on the specific requirements of the down-stream process and the end-product characteristics, sorting criteria based on the collected and calculated information is designed and programmed so the log after moisture scanning can be directed to the target log bin for the down-stream process.

### DETAILED DESCRIPTION OF THE PREFERRED EMBODIMENTS

In the examples below, all resin, waxes and other additives were added based on the oven-dry weight of the wood furnish. The following examples are intended to show potential embodiments of the invention and are not intended as providing any limitations to the invention.

Log Sorting and Lumber/Board Nondestructive Testing for Strand Production and Final Products

### EXAMPLE 1

Short leaf (SL) pine solid logs were sawn into 2″×4″ lumbers with a target length of 8 feet long. Twenty pieces of lumber were tested using a nondestructive evaluation technique known as transverse vibration to determine the dynamic modulus of elasticity. The procedure utilizes an oscilloscope to measure the frequency of a waveform generated by inducing a fundamental mode of transverse vibration in the simply supported beam configuration. The obtained frequency is used to calculate the dynamic modulus of elasticity. The means [standard deviation] of obtained dynamic MOE for Short Leaf pine is 1315 [319] (kpsi) for the non-destructive tested (NDT) sawn lumbers. The special MOE(para.) of tested panels is determined by the following formula: S_MOE(para.)=MOE(para.)/(OSB Density). The S_MOE(para.) for example 1 is 37.6 (kpsi)/(pcf).

### EXAMPLE 2

Loblolly (LP) pine solid logs were sawn into 2″×4″ lumbers. By using the same procedures as example 1, the dynamic MOE for LP pine is 948[173] (kpsi). The S_MOE(para.) for example 2 is 28.7 (kpsi)/(pcf).

### EXAMPLE 3

The same types of raw log materials were stranded using a commercially available ring strander into the following target strand dimension: 7.125″ long×0.03″ thick. Then, the furnishes were dried separately in third party laboratory to a target moisture content of 3-5% for core layer and 7-9% for face layer. The furnishes were pre-blended with each other in a ratio of SL to LP of 50 to 50 by wt %. 1.5% powder phenolic resin, 4% of MDI was sprayed in the cylindrical blender with face layer furnishes. 3.5% of MDI resin was sprayed in the cylindrical blender with core layer furnishes. 2% commercially available emulsion wax was sprayed for both face and core layer furnishes. The percentage of face layer to core layer furnishes by weight was 60 to 40 for all OSB panels with core layer furnishes aligned perpendicular to both the top and bottom surface layers of OSB panels. Strand mats were formed with a target density of 45 (pcf). Two oriented strand boards with a dimension of 23/32″×34″×34″ were manufactured using a steam injected hot press. With a steam injection pressure between 10-40 (psi) for about 30 (second) from the perforated holes on the platen surface before the hot press is closed, the loosely formed OSB mats were greatly plasticized and the curing of polymeric resin in the mats was accelerated in the subsequent hot pressing operation. The hot press setting parameters, including: heating temperature=205° C., pressing closing time=15-30 (second), cooking time=210 (second), and press opening time=60 (second), were applied during pressing operation. Then, the panels were cut into designated samples according to ASTM D1037 standards. The tested OSB panels had MOE (parallel)=955 (kpsi), MOE (perpendicular)=177 (kpsi) at an actual density of 46.2 (pcf) in according to ASTM D 1037 testing standard. The S_MOE(para.) for example 3 is 20.7 (kpsi)/(pcf). Thus, when compared with Example 4, below, it is shown that pre-blending of strands from two different types of logs (in terms of MOE ranges) in specific proportions can provide different grades of final oriented strand board products.

### EXAMPLE 4

The same types of raw log materials were stranded using a commercially available ring strander into the following target strand dimension: 7.125″×0.03″. The furnishes were pre-blended with each other in a ratio of SL/LP=25/75 by wt %. The MDI resin surface loading level in example is 6%. All other control parameters were set as in Example 3. The tested OSB panels had MOE (parallel)=734 (kpsi), MOE (perpendicular)=175 (kpsi) at an actual density of 44.2 (pcf) in according to ASTM D 1037 testing standard. The S_MOE(para.) for example 4 is 16.5 (kpsi)/(pcf).

### EXAMPLE 5

The same types of raw log materials were stranded using a commercially available ring strander into the following target strand dimension: 7.125″×0.03″. Then, the furnishes were dried separately in third party laboratory to a target moisture content of 3-5% for core layer and 7-9% for face layer. The furnishes were pre-blended with each other in a ratio SL to LP of 25 to 75 by wt %, 1.5% powder phenolic resin, 4% of MDI for surface layers in a cylindrical blender. 3.5% of MDI resin was sprayed in the cylindrical blender with core layer furnishes. 2% commercially available emulsion wax was sprayed in a cylindrical blender for both face and core layer furnishes. The percentage of face layer to core layer furnishes by weight was 60 to 40 for all OSB panels with core layer furnishes aligned perpendicular to both the top and bottom surface layers of manufactured OSB panels. Strand mats were formed with a target OSB density of 40 (pcf). Two oriented strand boards with a dimension of 23/32″×34″×34″ were manufactured using conventional multi-opening manufacturing technology. The hot press setting parameters, including: hot press temperature=205° C., pressing closing time=15-30 (second), cooking time=210 (second), and press opening time=60 (second), were applied during pressing operation. Then, the panels were cut into designated samples according to ASTM D1037 standards. The tested OSB panels had MOE (parallel)=768 (kpsi), MOE (perpendicular)=182 (kpsi) at an actual density of 40.86 (pcf) in according to ASTM D 1037 testing standard. The S_MOE(para.) for example 5 is 18.8 (kpsi)/(pcf).

### EXAMPLE 6

The same types of raw log materials were stranded using a commercially available ring strander into the following target strand dimension: 9.5″×0.03″. Then, the furnishes were dried separately in third party laboratory to a target moisture content of 3-5% for core layer and 7-9% for face layer. The furnishes were pre-blended with each other in a ratio SL to LP of 25 to 75 by wt %. 1.5% powder phenolic resin, 6% MDI resin. 3.5% of MDI resin was sprayed in the cylindrical blender with core layer furnishes. 2% commercially available emulsion wax was sprayed in a cylindrical blender for both face and core layer furnishes. The percentage of face layer to core layer furnishes by weight was 60 to 40 for all OSB panels with core layer furnishes aligned perpendicular to both the top and bottom surface layers of manufactured OSB panels. Strand mats were formed with a target OSB density of 40 (pcf). Two oriented strand boards with a dimension of 23/32″×34″×34″ were manufactured using conventional multi-opening manufacturing technology. The hot press setting parameters, including: hot press temperature=205° C., pressing closing time=15-30 (second), cooking time=210 (second), and press opening time=60 (second), were applied during pressing operation. Then, the panels were cut into designated samples according to ASTM D1037 standards. The tested OSB panels had MOE (parallel)=1257 (kpsi), MOE (perpendicular)=182 (kpsi) at an actual density of 40.1 (pcf) in according to ASTM D 1037 testing standard. The S_MOE(para.) for example 6 is 31.4 (kpsi)/(pcf)

### EXAMPLE 7

The previous Short leaf pine was selected based upon NDT testing results and first down sized into 0.75″ boards and then, stranded into strand with a size of 7.125″×0.003″×0.75″ (via a 3D stranding technique). These uniform SL strands were coated with 5.5% of MDI resin, 2.5% wax in a cylindrical blender. The resin-coated mats were aligned into 30″×30″ single layered oriented strand boards with a target thickness of 7/16″ uni-directionally using a robot-forming machine. The aligned strands had a target angular deviation of zero degree and density of 46 (pcf). The obtained composite panels had an actual MOE(flat)=1.836 (kpsi) at an actual density of 47.7 (pcf) and MOE(edgewise)=1.701 (kpsi) at an actual density of 46 (pcf) according to ASTM D 198. The S_MOE(para.) for example 7 is 39.6 (kpsi)/(pcf).

In the included examples (1 vs 2), Short leaf (SL) pine lumber has a higher MOE in bending than Loblolly (LP) lumber pine. The special MOE(para.) for SL pine is much higher than for LP pine. Clearly, NDT provides an effective tool for differentiating the sawn lumber quality of different species.

In comparison of examples (3 vs 4 and 5), the S_MOE(para.) for example 3 is higher than for examples 4 and 5. That is, strands made of high quality sawn board/lumbers will make higher performance OSB products when high quality wood strand elements are produced from these raw materials regardless of OSB manufacturing processes (either multi-opening conventional hot press or steam injected pre-heating continuous pressing, or steam injected hot press).

In comparison of example 6 with examples 3, 4, 5, clearly, the length of strands also plays crucial role in controlling the S_MOE(para.). The OSB, made of 9.5″ long strands from example 6, provides a better OSB bending MOE than from examples 3-5.

For high end OSB or OSL products, pre-selection of SL pine raw materials was performed in Example 6. The single layered OSB/OSL products made of stiffner SL pine species in example 6 provide excellent bending MOE with a actual S_MOE(para.)=39.6 (kpsi)/(pcf). This special MOE(para.) is close to the special MOE of original SL lumbers.

In summary, the NDT testing method provides an effective screening tool for wood based composite raw material quality control and tailoring the final performance of delivered OSL and OSB products.

OSB and OSL Performance Due to the Sorting and Selection of Raw Materials

### EXAMPLE 8

Southern yellow pine (SYP) logs were processed into strands with a target length of 7.125″ and thickness of 0.030″ using a commercially available ring strander. These strands were dried to target moisture content of 3-6%, then, screened with pilot lab disk screening equipment. The recovery rate of screened SYP strands is about 50%. 5.5% polymeric MDI resin (Hunstman) and 1.5% emulsion wax (Borden Chemicals) were applied on the above wood strands. The resinated strands were felt on a pilot orienting station with majority of strands aligned primary along the strand length direction. The formed mats are pressed with 4′×8′ steam injected hot press following a two-step pre-heating/hot pressing schedule. The final target thickness of manufactured OSL products is 1.75′

### EXAMPLE 9

Aspen wood strands with target length of 6″ and thickness of 0.03″ were manufactured using a commercially available disk strander with regular OSB manufacturing processes. The manufactured OSL panel product is the same as example 8.

### EXAMPLE 10

Southern yellow pine wood logs were first cut into boards with a target thickness of 0.75″. Then, about 10 boards were stacked together and fed into a commercially available ring strander to cut the boards with strand size in length of 7.125″ and thickness of 0.030″. These strands were dried to 6% target moisture content and screened so that all strands would have the desirable sizes. 5.5% polymeric MDI resin (Huntsman ICI) and 1.5% emulsion wax (Borden Chemicals) were applied on the above wood strands in a lab resin applicator. The resinated strands were formed into unidirectional single-layered mats with a robot controlled forming machine with defined angular deviation of each individual strand. Then, the formed mats are pressed with 34″×30″ lab hot press at a target thickness of 7/16″.

The follow mechanical properties of tested OSL were determined according to the ASTM D 198 and ASTM D 5456:

(1). MOE (edge) in parallel (4 point bending)

(2). MOE (flat) in parallel (3 point bending)

(3). MOE (edge) in perpendicular (4 point bending)

(4). MOE (flat) in perpendicular (3 point bending)

TABLE 1
Tested New Invented OSB Performance Attributes

| | SCL Products | Thickness | MOE (e) | | MOE (f) | | MOE Ratio | MOE Ratio |
|---|---|---|---|---|---|---|---|---|
| Ex. | Orientation | (inches) | Means | SD | Means | SD | (e/f) | (Para/Perp) |
| 8 | Parallel | 1.75 | 1.21 | 0.03 | 1.382 | 0.05 | 0.88 | 4.2 |
| 8 | Perpendicular | 1.75 | 0.277 | 0.06 | 0.345 | 0.07 | | |
| 9 | Parallel | 1.75 | 1.82 | 0.02 | 1.491 | 0.06 | 1.22 | 7.5 |
| 9 | Perpendicular | 1.75 | 0.229 | 0.02 | 0.216 | 0.04 | | |
| 10 | Parallel | 7/16 | 1.67 | 0.22 | 1.75 | 0.16 | 0.96 | 13.5 |
| 10 | Perpendicular | 7/16 | 0.127 | 0.04 | 0.127 | 0.04 | | |

The means and standard deviation of the tested MOE values are listed in Table 1. The ratio of MOE(parallel, edge) to MOE(parallel, flat) and ratio of MOE(parallel) to MOE(perpendicular) are also calculated and listed as a performance index. Evidently, for strand-based SCL products such as LSL and OSL using regular 2-D strands, products with a ratio of MOE( parallel, edge) to MOE(parallel, flat)≈1.0 are not achievable. However, OSL products using 3-D SYP strands developed using robot forming will have an average MOE(edge)/MOE(flat)=0.96 and MOE(flat) or MOE(edge)>=1.50 (mmpsi), and ratio of MOE(parallel) to MOE(perpendicular)>9.2, which will meet the desirable characters of OSL and OSB composites.

Other Log/Lumber Sorting Processes

### EXAMPLE 11

### Log Scanner Equipment

The laser scanning equipment is readily available from commercial sources. For example, the LPS-2016 Laser Profile Scanner from Hermary Opto Electronics, Inc. This is a fully integrated co-planar scanning system designed to scan logs and cants in sawmilling applications.

Another scanner from the same manufacturer is the HDS-050 High Definition Diameter Scanner is an infrared scanner inside aluminum housing, designed for log diameter measurement. The resolution is 0.050″.

The L1 3D log scanner from LMI Technologies, Inc. is another example of high resolution log profiling. Three of these would give you a full 3D image around the log.

### EXAMPLE 12

### Strands Produced After Sorting Via Static Bending

The equipment for static bending measurement of MOE of the logs could be:
1—A support system of two supports a fixed distance apart that have a cupped support surface to positively support logs of different shapes and diameters.
2—Two loading points with a fixed spacing so that the distance between the supports is exactly one-third the total distance between the centers of the two supports. There would be a load cell on the base of the loading points so that the load being applied to the log can be accurately measured.
3—A measurement device that calculates the relative deflection of the center of the log with respect to the deflection at the loading points. This could be based on LVDTs, String-pots, or preferably laser deflection sensors. An example of a laser sensor that could very accurately measure the deflection at these points is the LDS—Laser Distance Sensor from LMI Technologies, Inc.
4—A hydraulic or mechanical displacement control that would induce a deflection of 0.1 to 0.5″ (to be determined).
5—A computer system that correlates the deflection measurements, load sensors, and log density (weight/volume) to the equation of static bending MOE.
6—Possibly, a log rotation device to rotate and measure the MOE perpendicular to the first measurement.
7—The log is then sent out of the MOE are on the conveyor, to be sorted with the log sorting equipment, and thereby sent to a specific area for use in one of two or more products, depending on the end use assigned by the computer algorithm.
   Further Sorted Log/Lumber Products (with Conditioning)

### EXAMPLE 13

Southern yellow pine wood logs were stranded using a commercially available disk strander. The size of the strands in length was within a range of 4.5″ to 5.25″ and thickness of 0.02 to 0.04″. The samples were dried to moisture content of 4-6%.

### EXAMPLE 14

Aspen wood logs were first debarked and immersed in a water vat for about 8 to 12 hour at vat tank temperature of 130 to 150° F. to melt the ices and fully condition the logs. The logs were crosscut into short pieces with a target length of 32″. Then, the short logs were firmly fed into a commercially available disc strander with a target strand size of length: 4.25″, target thickness: 0.025-0.03″. The strands were dried in a commercial rotary dryer to a moisture content of 4.5-6.5%.

### EXAMPLE 15

Softwood species (Tamarack) were sawn into 1″ boards with a target length of 8 feet. The boards were cut into wood blocks (flitch) with a target size of 10″×1.0″. Then, wood board/blocks were treated with a water tank. The water soaked boards/blocks were subsequently frozen in a freezer for about 24 hours at −20° C. Once the wood blocks were taken out from the freezer, 5-8 pieces of these frozen wood blocks were stacked together and machined into strands with a target thickness of 0.028″.

### EXAMPLE 16

Softwood species (Tamarack) were sawn into 1″ boards with a target length of 8 feet. The boards were cut into wood blocks with a target size of 10″×1″. Then, wood board/blocks were conditioned with a water tank. 5-8 pieces of these unfrozen wood blocks were stacked together and machined into strands with a target thickness of 0.028″.

### EXAMPLE 17

Softwood species (Tamarack) were sawn into 1″ boards with a target length of 8 feet. The boards were conditioned with water sprinkler for about two hours. Then, the boards were stacked together and fed into a commercially available CAE strander and stranded into a target dimension of 7.125″×0.03″×1″ with a clamping device.

### EXAMPLE 18

Aspen logs were sawn into 1″ boards with a target length of 8 or 16 feet. The boards were sprayed with garden sprinkler for about 2 hours before stranding. Then, the boards were stacked together and fed into a CAE ring strander and stranded into a target strand dimension of 7.125″×0.03″×1″ with a clamping device.

The size distribution and % yield of furnishes from examples 1 to 6 were measured by a Gibson's sieving machine. The results are listed in Table 1. The results from these examples can be summarized as follows:

In comparison of example 13 with example 14, aspen logs conditioned with hot water vats will create much less fines than Southern yellow pine without pre-condition.

In comparison of example 15 with example 16, unfrozen lumber/boards (example 16) generate much less fines than frozen board/lumbers (example 15). Also, much less breakage takes place in sample from example 16 than from example 15.

In a comparison of example 14 with examples 17 or 18, the testing results indicate that time needed for conditioning boards is only 2 hours much shorter than log conditions (8-12 hours). The retaining % of screened furnishes with ¾″ mesh in example 2 is 55.8% much less than that in examples 17 or 18 that has a retaining % of screened furnishes (62.3% or 70.8%).

As such, conditioning sawn board/lumbers instead of logs will allow the processed materials to be fully softened in a short time. High quality wood strand elements can be obtained for making high performance OSL/LSL or/and OSB products.

TABLE 2
% Yield Determined by Gilson's Sieving
classification Machine (Wt %)

| Examples | Fines (−⅛″) | +⅛″ −⅜″ | +⅜″ −¾″ | +¾″ |
|---|---|---|---|---|
| 13 | 29.6 | 27.7 | 11.5 | 31.2 |
| 14 | 9.2 | 18.9 | 16.1 | 55.8 |
| 15 | 8.6 | 24.2 | 28.9 | 38.3 |
| 16 | 5.4 | 15.2 | 25.3 | 54.1 |
| 17 | 10.7 | 12.2 | 14.8 | 62.3 |
| 18 | 5.1 | 7.8 | 16.3 | 70.8 |

It will be understood that various changes in the details, materials, and arrangements of the parts which have been described and illustrated herein in order to explain the nature of this invention may be made by those skilled in the art without departing from the principles and scope of the invention as expressed in the following claims.

What is claimed is:

1. A method of producing an engineered wood product, the method comprising i) initially cutting logs into separate lumber pieces; ii) optionally conditioning said lumber pieces in a heat treatment; iii) sorting said lumber pieces through assessing any of the following raw material characteristics in relation to a predetermined criteria: a) modulus of elasticity; b) density (specific gravity); c) size and shape; and any combinations thereof; iv) stranding those lumber pieces that meet preselected raw material characteristic measurements; and v) incorporating the strands exhibiting such raw material characteristics within an engineered wood product.

2. The method of claim 1 wherein said strands exhibit dimensions from 4″ to 12″ in length, 0.05″ to 3″ in width, and 0.005″ to 0.05″ in thickness.

3. The method of claim 1 wherein said optional step “ii” is present.

4. The method of claim 1 wherein said step “ii” includes a heat treatment selected from the group consisting of steam treatment, and/or hot water immersion thereof.

5. The method of claim 3 wherein said strands exhibit dimensions of from 3″ to 9.5″ in length, 0.5″ to 2″ in width, and 0.02″ to 0.05″ in thickness.

6. The method of claim 4 wherein said strands exhibit dimensions of from 4.5″ to 8″ in length, 0.5″ to 1.5″ in width, and 0.02″ to 0.05″ in thickness.

7. The method of claim 1 wherein said raw material characteristic is a), and the measured modulus of elasticity (MOE) determined by NDT measurements for lumber is from 0.2 to 1.0 (mmpsi).

8. The method of claim 1 wherein said raw material characteristic is a), and the measured modulus of elasticity (MOE) determined by NDT measurements for logs and/or lumber is in excess of 1.0 up to 1.5 E (mmpsi) in strand fiber direction.

9. The method of claim 1 wherein said raw material characteristic is a), and the measured modulus of elasticity (MOE) determined by NDT measurements for logs and/or lumber is in excess of 1.5 up to 2.0 E (mmpsi) in strand fiber direction.

10. The method of claim 1 wherein said raw material characteristic is a), and the measured modulus of elasticity (MOE) determined by NDT measurements for logs and/or lumber is in excess of 2.0 up to 2.5 E (mmpsi) in strand fiber direction.

11. The engineered wood product produced by the method of claim 7.

12. The engineered wood product produced by the method of claim 8.

13. The engineered wood product produced by the method of claim 9.

14. The engineered wood product produced by the method of claim 10.
